(19) United States
(12) Patent Application Publication
(10) Pub. No.: US 2013/0282702 A1
(43) Pub. Date: Oct. 24, 2013

(54) METHOD AND SYSTEM FOR SEARCH ASSISTANCE

(71) Applicants: Shenhong Zhu, Santa Clara, CA (US); Jim Gan, Cupertino, CA (US); Hang Su, Sunnyvale, CA (US); Xiaobing Han, San Jose, CA (US); Ethan Batraski, Foster City, CA (US)

(72) Inventors: Shenhong Zhu, Santa Clara, CA (US); Jim Gan, Cupertino, CA (US); Hang Su, Sunnyvale, CA (US); Xiaobing Han, San Jose, CA (US); Ethan Batraski, Foster City, CA (US)

(73) Assignee: YAHOO! INC., Sunnyvale, CA (US)

(21) Appl. No.: 13/449,568

(22) Filed: Apr. 18, 2012

(51) Int. Cl. G06F 17/30

(52) U.S. Cl. 707/723; 707/767; 707/E17.014; 707/E17.066

(57) ABSTRACT

Method, system, and programs for intent-based search assistance are disclosed. Intent information associated with a query entered by a user is first collected. The intent information includes one or more intents. The collected intent information is then associated with annotation information to generate annotated intent information for the query. In response to the user entering the query, a query suggestion is determined from a plurality of query suggestions. Content is then provided to the user at real-time based on the determined query suggestion and the annotated intent information for the query.

### CROSS-REFERENCE TO RELATED APPLICATION

This application is related to co-pending application having application Ser. No. ______, docket number 30016020-0231, filed on even date, having inventors Ethan Batraski et al., entitled “METHOD AND SYSTEM FOR SEARCH SUGGESTION,” owned by instant assignee.

### BACKGROUND

1. Technical Field

The present teaching relates to methods, systems, and programming for Internet services. Particularly, the present teaching is directed to methods, systems, and programming for search assistance.

2. Discussion of Technical Background

Online content search is a process of interactively searching for and retrieving requested information via a search application running on a local user device, such as a computer or a mobile device, from online databases. Online search is conducted through search engines, which are programs running at a remote server and searching documents for specified keywords and return a list of the documents where the keywords were found. Known major search engines have features called “search assistance” designed to help users narrow in on what they are looking for. For example, search assistance may include a “search suggestion” feature that, as users type a search query, displays a list of query suggestions that have been used by many other users before to assist the users in selecting a desired search query. Another feature in search assistance is “search direct answer,” which gives users the answers to their search queries before they hit the actual search button or any specific hyperlink.

FIG. 1 illustrates a prior art system 100 for search assistance. The prior art system 100 includes a search assistance engine 102 and a search serving engine 104. A user 106 in this example interacts with the search serving engine 104 to provide a search query and receive query results, e.g., a list of hyperlinks. At the same time, the search query is also utilized by the search assistance engine 102, specifically, by a search suggestion module 108 and a search direct answer module 110, to provide search assistance. For example, the search suggestion module 108 may return and update a list of query suggestions by analyzing offline query and search logs database based on the query string, i.e., a partial search query, as the user 106 types. The search direct answer module 110 may return and update the most relevant content as a direct answer to the search suggestions returned by the search suggestion module 108.

In one example shown in FIG. 2, when a user enters a partial search query “faceb” in a search box, a list of query suggestions including “facebook,” “facebook sign up,” “facebook law,” etc., are presented to help the user choose a desired search query. As the user types, i.e., changing of the query string, the list may be updated. Also, in this example, the homepage of FACEBOOK is displayed as the direct answer to the highlighted search suggestion, which is the top suggestion by default in the right panel. However, because the search assistance is performed based on periodically analyzing historical query logs offline, the results provided by the known search assistance solutions are sometimes obsolete and inaccurate. In this example, although most of the time, the official website of FACEBOOK is a desired direct answer to the partial search query “faceb” and the highlighted search suggestion “facebook” at a certain time, e.g., when FACEBOOK just released its IPO news, news related to FACEBOOK IPO would be a more updated and relevant direct answer.

In another example shown in FIG. 3, a search query “Rome” is entered in the search box by a user. As the user types, the search suggestions refresh, and the direct answer to the top highlighted suggestion is displayed on the right panel. The area for displaying the direct answer is confined, while there are multiple possible answers that the user may be looking for. For example, “Rome” could mean the city where the user wants to visit, the movie “Rome,” or the stock ticker of the corresponding company, etc. Thus, it is not easy for the known search assistance solutions to arrange the presentation in the right panel to include all possible answers due to the ambiguity with multiple potential intents.

Therefore, there is a need to provide an improved solution for search assistance to solve the above-mentioned problems.

### SUMMARY

The present teaching relates to methods, systems, and programming for Internet services. Particularly, the present teaching is directed to methods, systems, and programming for search assistance.

In one example, a method, implemented on at least one machine each of which has at least one processor, storage, and a communication platform connected to a network for intent-based search assistance, is disclosed. Intent information associated with a query entered by a user is first collected. The intent information includes one or more intents. The collected intent information is then associated with annotation information to generate annotated intent information for the query. In response to the user entering the query, a query suggestion is determined from a plurality of query suggestions. Content is then provided to the user at real-time based on the determined query suggestion and the annotated intent information for the query.

In another example, a method, implemented on at least one machine each of which has at least one processor, storage, and a communication platform connected to a network for intent-based search assistance, is disclosed. A query entered by a user is first received. A plurality of query suggestions and annotated intent information associated with at least one of the plurality of query suggestions are received. The annotated intent information includes one or more intents determined based on the at least one query suggestion. The plurality of query suggestions are presented to the user. The at least one query suggestion is presented with one or more labels each indicating one of the one or more intents. Content obtained based on the at least one query suggestion and annotation information associated with an intent is received and presented to the user at real-time. The intent is determined based on the query entered by the user.

In a different example, a system for intent-based search assistance is disclosed. The system comprises an online query intent collecting module, a query intent processing module, an intent-based query suggestion module, and an intent-based query direct answer module. The online query intent collecting module is configured to collect intent information associated with a query entered by a user. The intent information includes one or more intents. The query intent processing module is configured to associate the collected intent information with annotation information to generate annotated intent information for the query. The intent-based query suggestion module is configured to, in response to the user entering the query, determine a query suggestion from a plurality of query suggestions. The intent-based query direct answer module is configured to provide content to the user at real-time based on the determined query suggestion and the annotated intent information for the query

In another example, an apparatus for intent-based search assistance is disclosed. The apparatus comprises a transmitter, a receiver, and a display. The transmitter is configured to send a query entered by a user. The receiver is configured to receive a plurality of query suggestions and annotated intent information associated with at least one of the plurality of query suggestions. The annotated intent information includes one or more intents determined based on the at least one query suggestion. The receiver is also configured to receive content obtained based on the at least one query suggestion and annotation information associated with an intent. The intent is determined based on the query entered by the user. The display is configured to present the plurality of query suggestions to the user. The at least one query suggestion is presented with one or more labels each indicating one of the one or more intents. The display is also configured to present the content to the user at real-time.

Other concepts relate to software for intent-based search assistance. A software product, in accord with this concept, includes at least one machine-readable non-transitory medium and information carried by the medium. The information carried by the medium may be executable program code data regarding parameters in association with a request or operational parameters, such as information related to a user, a request, or a social group, etc.

In one example, a machine readable and non-transitory medium having information recorded thereon for intent-based search assistance, wherein the information, when read by the machine, causes the machine to perform a series of steps. Intent information associated with a query entered by a user is first collected. The intent information includes one or more intents. The collected intent information is then associated with annotation information to generate annotated intent information for the query. In response to the user entering the query, a query suggestion is determined from a plurality of query suggestions. Content is then provided to the user at real-time based on the determined query suggestion and the annotated intent information for the query.

In another example, a machine readable and non-transitory medium having information recorded thereon for intent-based search assistance, wherein the information, when read by the machine, causes the machine to perform a series of steps. A query entered by a user is first received. A plurality of query suggestions and annotated intent information associated with at least one of the plurality of query suggestions are received. The annotated intent information includes one or more intents determined based on the at least one query suggestion. The plurality of query suggestions are presented to the user. The at least one query suggestion is presented with one or more labels each indicating one of the one or more intents. Content obtained based on the at least one query suggestion and annotation information associated with an intent is received and presented to the user at real-time. The intent is determined based on the query entered by the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts a prior art system for search assistance;

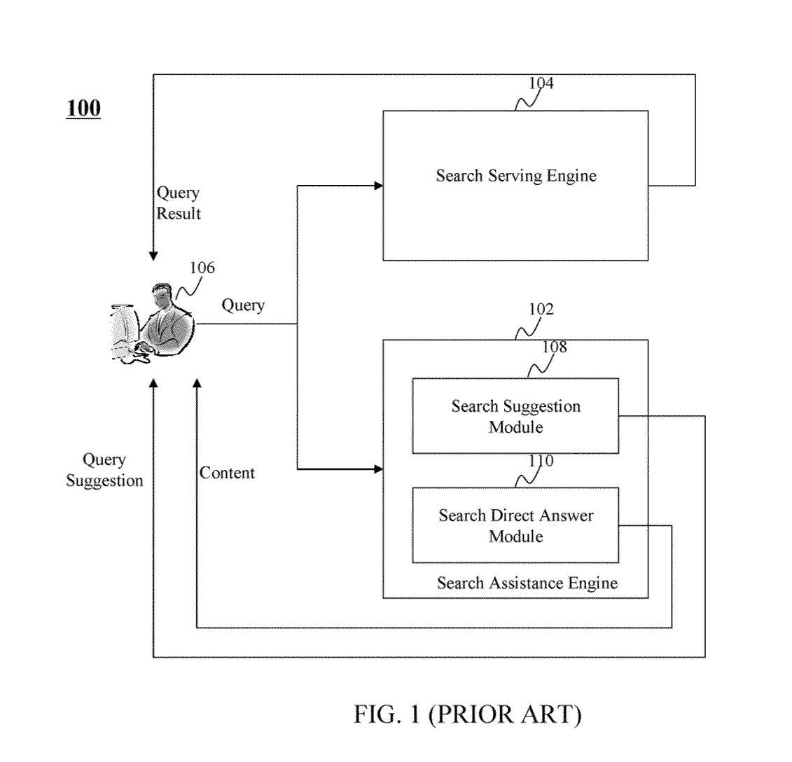

FIG. 2 illustrates one example of search assistance by the prior art system shown in FIG. 1;

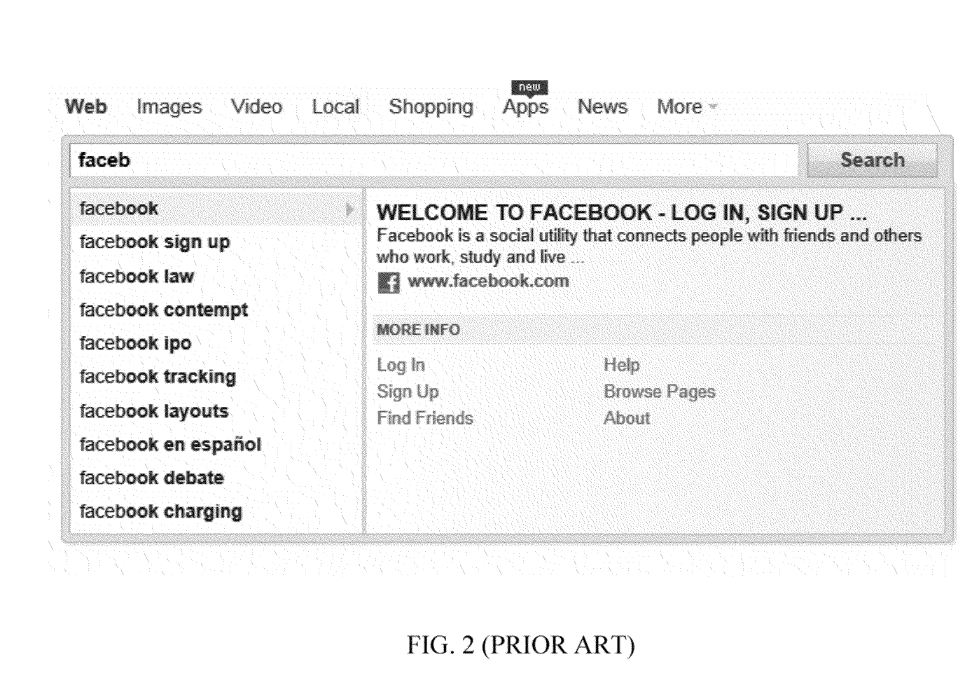

FIG. 3 illustrates another example of search assistance by the prior art system shown in FIG. 1;

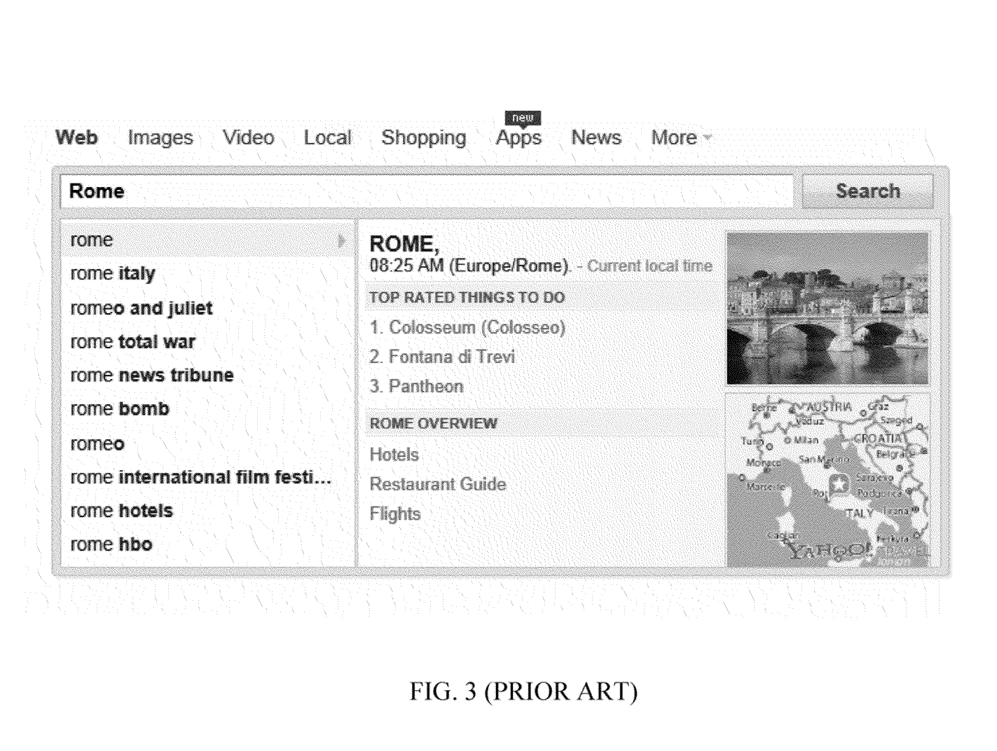

FIG. 4 is a high level exemplary system diagram of a system for intent-based search assistance, according to an embodiment of the present teaching;

FIG. 5 is a flowchart of an exemplary process for intent-based search assistance, according to an embodiment of the present teaching;

FIG. 6 is an exemplary diagram of a search serving engine of the system for intent-based search assistance shown in FIG. 4, according to an embodiment of the present teaching;

FIG. 7 is a flowchart of an exemplary process for a search serving engine of the system for intent-based search assistance, according to an embodiment of the present teaching;

FIG. 8 is an exemplary diagram of a query intent processing module of an intent-based search assistance engine of the system for intent-based search assistance shown in FIG. 4, according to an embodiment of the present teaching;

FIG. 9 is a flowchart of still another exemplary process for intent-based search assistance, according to an embodiment of the present teaching;

FIG. 10 is an exemplary diagram of an intent-based query direct answer module of an intent-based search assistance engine of the system for intent-based search assistance shown in FIG. 4, according to an embodiment of the present teaching;

FIG. 11 is a flowchart of yet another exemplary process for intent-based search assistance, according to an embodiment of the present teaching;

FIG. 12 is an exemplary diagram of an intent-based query suggestion module of an intent-based search assistance engine of the system for intent-based search assistance shown in FIG. 4, according to an embodiment of the present teaching;

FIG. 13 is a flowchart of yet another exemplary process for intent-based search assistance, according to an embodiment of the present teaching;

FIG. 14 depicts one example of the relationship between query, intent, and intent annotation information, according to an embodiment of the present teaching;

FIG. 15 depicts one example of intent grouping and categories, according to an embodiment of the present teaching;

FIG. 16 illustrates one example of search assistance by the system for intent-based search assistance shown in FIG. 4;

FIG. 17 illustrates another example of search assistance by the system for intent-based search assistance shown in FIG. 4;

FIG. 18 depicts an exemplary embodiment of a networked environment in which intent-based search assistance is applied, according to an embodiment of the present teaching;

FIG. 19 is a flowchart of yet another exemplary process for intent-based search assistance, according to an embodiment of the present teaching;

FIG. 20 is a flowchart of yet another exemplary process for intent-based search assistance, according to an embodiment of the present teaching; and

FIG. 21 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of efficient and effective search assistance. The method and system as disclosed herein aim at improving end-users' search experience by instantly providing more relevant query suggestions and the most relevant direct answer based on the users' search intents. The present disclosure describes a real-time query intent feedback eco-system from a search serving system, which can do heavy computing about user intents based on query analysis, search engine results, and user click feedbacks, etc., to a search assistance system, which requires high performance and very low latency response since query suggestion must come out instantly as a user types. Compared with known solutions, the method and system solve the need for search engines to guess a user's intent by exposing the various intents available for an ambiguous query so that the user could select the desired query suggestion and proceed.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

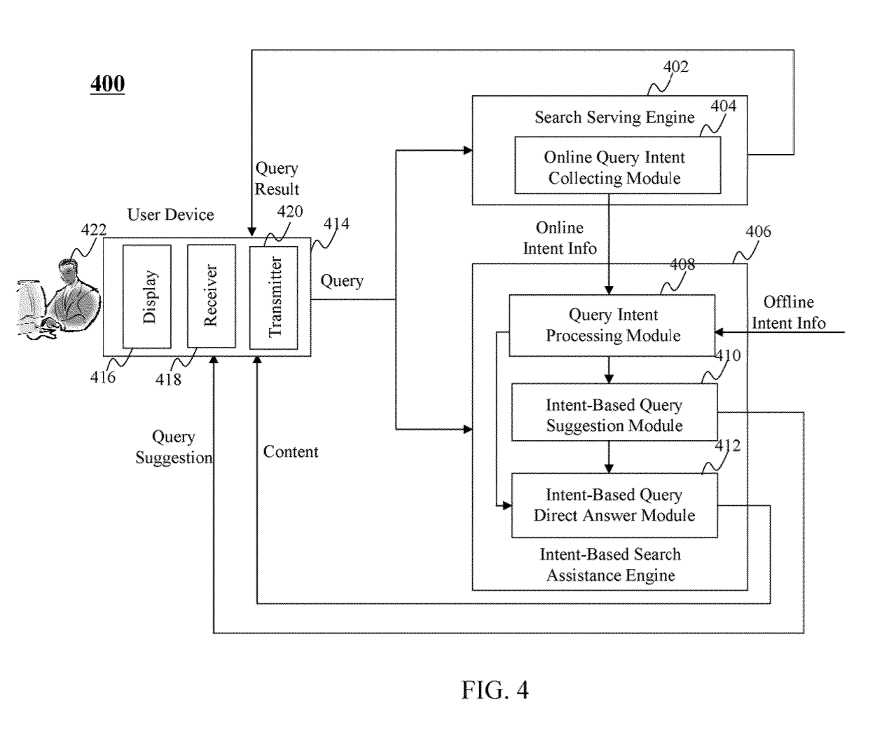

FIG. 4 is a high level exemplary system diagram of a system for intent-based search assistance, according to an embodiment of the present teaching. The system 400 in this example includes a search serving engine 402 having an online query intent collecting module 404, an intent-based search assistance engine 406 having a query intent processing module 408, an intent-based query suggestion module 410, and an intent-based query direct answer module 412, and a user device 414 having a display 416, a receiver 418, and a transmitter 420. A user 422 in this example performs an online search through the user device 414 and the backend search serving engine 402 and instantly gets search assistance from the remote intent-based search assistance engine 406 based on intent information collected both online and offline.

The user device 414 may be a laptop computer, desktop computer, netbook computer, media center, mobile device (e.g., a smart phone, tablet, music player, and GPS), gaming console, set-top box, printer, or any other suitable device. A search application, such as a web browser or a standalone search application, may be pre-installed on the user device 414 by the vendor of the user device 414 or installed by the user 422. The search application may serve as an interface between the user 422 and the remote search serving engine 402 and intent-based search assistance engine 406. The search application may be stored in a storage on the user device 414 and loaded into a memory once it is launched by the user 422. Once the search application is executed by one or more processors on the user device 414, the transmitter 420 of the user device 414 is responsible for sending a query, e.g., query string, entered by the user 422 to the remote search serving engine 402 and intent-based search assistance engine 406. The receiver 418 is configured to receive search assistance, including query suggestions and content of a direct answer from the intent-based search assistance engine 406. The receiver 418 may also receive query results, e.g., a list of hyperlinks, from the search serving engine 402 once the user 422 clicks the search button in the search application. The received query suggestions, content, and query results are presented to the user 422, for example, through the display 416 or any other suitable output devices.

The search serving engine 402 in this example may be any suitable search engine with the online query intent collecting module 404. The search serving engine 402 is responsible for analyzing the received query from the user device 414, detecting possible search intents, fetching query results, and providing the query results with the best intent to the user device 414. In particular, the online query intent collecting module 404 in this example is configured to collect intent information associated with the received query online and send the online intent information to the intent-based search assistance engine 406 at real-time. The intent information in this example may include one or more possible search intents. In addition to online intent information, offline intent information may be collected from, for example, an editorial feeds database, third party dumps database, and query log database, and fed into the intent-based search assistance engine 406.

The query intent processing module 408 of the intent-based search assistance engine 406 is configured to associate the collected intent information with annotation information to generate annotated intent information for the query. In this example, the intent-based query suggestion module 410 is configured to, in response to the user 422 entering the query, determine a query suggestion from a plurality of query suggestions based on their associated annotation information. The intent-based query suggestion module 410 is further configured to provide the list of query suggestions to the user device 414, including the determined query suggestion on top of the list with one or more labels, each indicating one intent. The intent-based query direct answer module 412 is configured to provide content of the direct answer to the user device 414 at real-time based on the query suggestion determined by the intent-based query suggestion module 410 and the annotated intent information for the query.

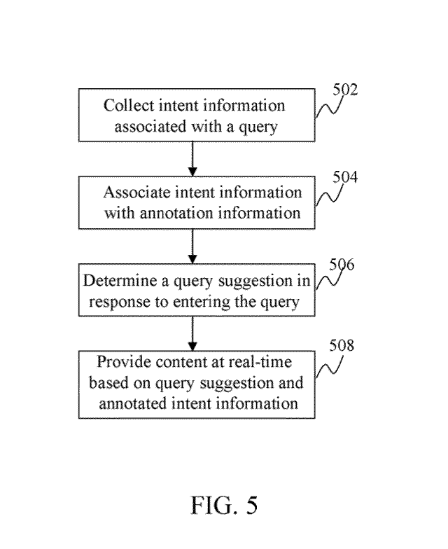

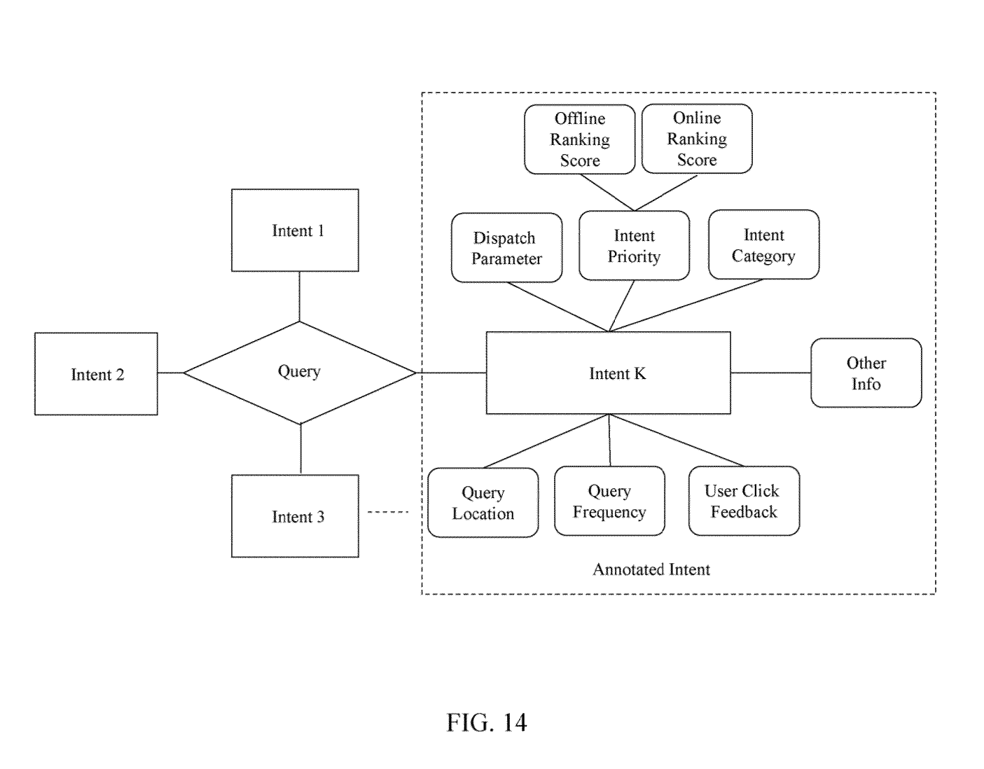

FIG. 5 is a flowchart of an exemplary process in which intent-based search assistance is performed, according to an embodiment of the present teaching. It will be described with reference to the above figures. However, any suitable module or unit may be employed. Beginning at block 502, intent information associated with a query entered by a user is collected. The intent information includes one or more possible intents indicating one or more topics/categories associated with the query. Referring now to FIG. 14, each query entered by a user is associated with one or more intents, i.e., intent 1 to intent k. For example, if users type “washing machine,” they may be looking for a store, a brand, a review, or a price, each of which is considered as a search intent. In another example, if the users enter “Jennifer Lopez,” the possible search intents may include “actress” and “singer.” In still another example, when the users input “adirondack chair,” they may be looking for plans to build their own, places to buy the chair, or way to maintain the chair, which may be considered as intents for “plans,” “local stores,” and “maintenance,” respectively. As described above, this may be performed by the online query intent collecting module 404 of the search serving engine 402.

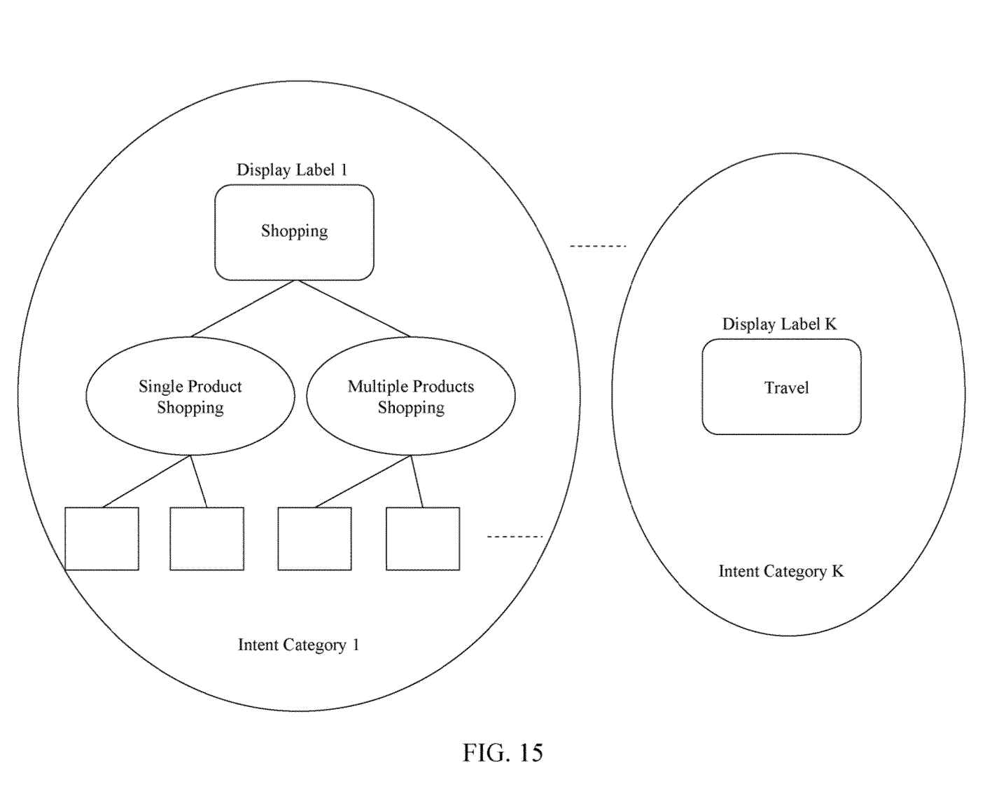

At block 504, processing may continue where the collected intent information is associated with annotation information to generate annotated intent information for the query. As described above, this may be performed by the query intent processing module 408 of the intent-based search assistance engine 406. As shown in FIG. 14, for each intent, the annotation information includes one or more attributes such as intent category, intent priority including offline and online ranking scores, query frequency, query location, user click feedback, dispatch parameter, and any other suitable information. The annotation information may be defined in a compact format so that the size of database for storing the annotation information is minimized. FIG. 15 illustrates one example of intent grouping and categories. Sometimes, intents may have very subtle differences, such as “single product shopping” vs. “multiple product shopping,” or “breaking news” vs. “regular news.” The various intents may be grouped into each predefined intent category. For each intent category, a label is assigned for display purpose when intents are presented with query suggestions. For example, one intent category may have a display label “shopping” while another intent category has a display label “travel.” Each intent category may include one or more intents organized based on a model, such as a hierarchical model in intent category 1. For intent category 1, the root node of the hierarchical model “shopping” is also used as the display label. In each category, a precedent list may be included to determine which intent should be chosen for the final dispatch parameter and ranking score for the category. The dispatch parameter may be any parameter used to make backend service calls to retrieve direct answer content for a particular intent. It is understood that a single intent may be included in some of the categories. The intent categories may be used as basic units for intent-based search assistance.

Moving to block 506, in response to the user entering the query, a query suggestion is determined from a plurality of query suggestions based on their associated annotation information, such as intent priority. As described above, this may be performed by the intent-based query suggestion module 410 of the intent-based search assistance engine 406. The determined query suggestion may be the most relevant query, which is associated with one or more intents with the highest priority, the best user feedback, and/or the highest search frequency. Other annotation information may be also taken into account when determining the most relevant query suggestion. In one example, the query location may be applied. For example, given the user's input of “nfl playoff,” a query suggestion “nfl playoff San Francisco 49ers” may be determined to be the most relevant query suggestion for San Francisco bay area users, while a suggestion “nfl playoff New York Giants” may be determined to be the most relevant query suggestion for New York City area users. In another example, the intent category may be taken into consideration. For example, query suggestions with news intent may be more likely considered as the most relevant query suggestion in order to provide breaking news kind of query suggestions and direct answers.

Eventually, at block 508, content is provided to the user at real-time as a direct answer to the query based on the determined query suggestion and the annotated intent information for the query. For example, the dispatch parameter in the annotated intent information may be used to retrieve content for a particular intent associated with the determined query suggestion. As described above, this may be performed by the intent-based query direct answer module 412 of the intent-based search assistance engine 406. Blocks 502, 504, 506, 508 are performed at real-time, such that the query intents collected at block 502 are instantly feedback from the search serving engine 402 to the intent-based search assistance engine 406 with minimum latency in order to provide the most relevant and fresh direct search answer.

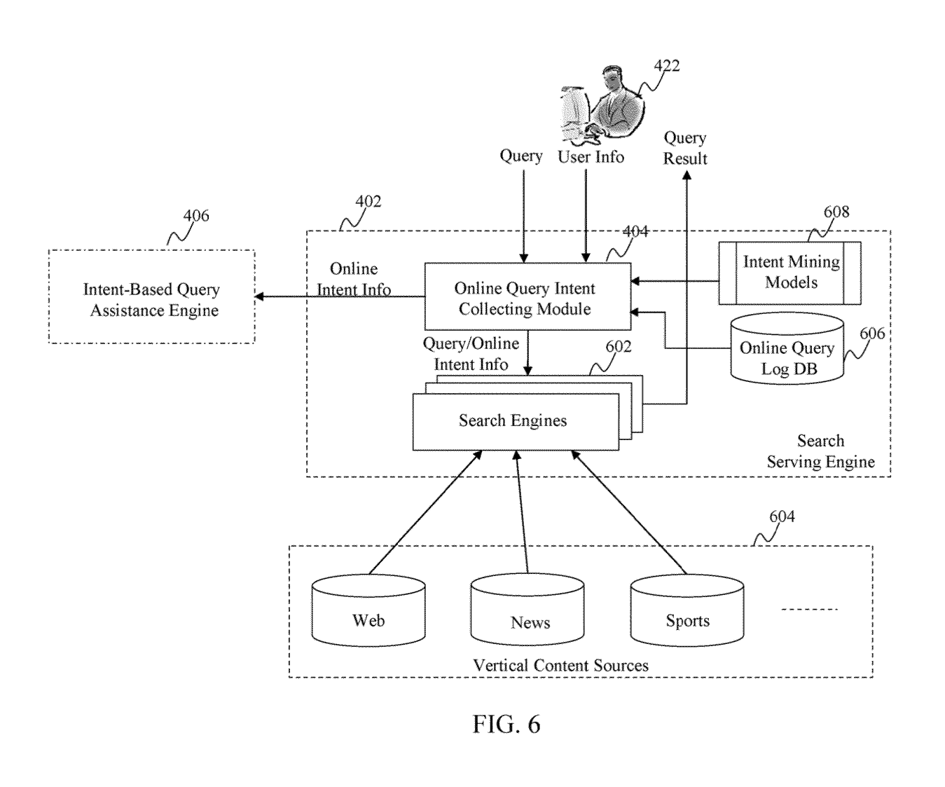

FIG. 6 is an exemplary diagram of a search serving engine of the system for intent-based search assistance shown in FIG. 4, according to an embodiment of the present teaching. The search serving engine 402 in this example includes the online query intent collecting module 404 and one or more search engines 602. As discussed above, the online query intent collecting module 404 collects online intent information based on the query entered by the user 422. In this example, the user information, such as user location or user basic attributes, e.g., age, gender, occupation, etc., may be obtained by the online query intent collecting module 404 for detecting possible search intents. The detection may be performed by data mining approaches on online query log database 606 using any known intent mining models 608. Time-sensitive intents are online collected in a continuous and real-time manner. The online intent information may be sent to the search engines 602 such that the search engines 602 could fetch results from vertical content sources 604, e.g., web, news, sports, etc., based on the query and return the query results with the best intent to the user 422 once the user 422 clicks the search button. In this example, if more than one intent is detected for a particular query, the online query intent collecting module 404 may further rank the intents based on data mining results and user click feedback. That is, an online ranking score, which is part of the intent priority as shown in FIG. 14, may be calculated, normalized, and assigned to each intent to indicate the degree of relevance to the associated query. The online intent information is also provided to the intent-based search assistance engine 406 at real-time.

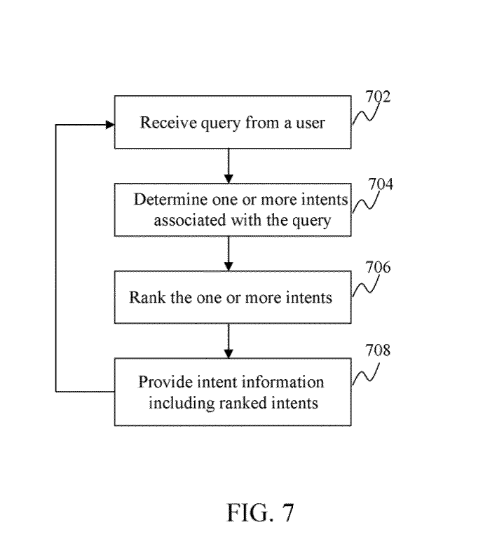

FIG. 7 is a flowchart of an exemplary process for a search serving engine of the system for intent-based search assistance, according to an embodiment of the present teaching. It will be described with reference to the above figures. However, any suitable module or unit may be employed. Beginning at block 702, a query is received from a user through a user device. At block 704, one or more intents associated with the query are determined using data mining approaches based on query logs at real-time. At block 706, the one or more intents are ranked based on data mining results and user click feedback. Moving to block 708, the online intent information including the ranked intents is provided to the intent-based query assistance engine and/or the search engines at real-time. The process is FIG. 7 runs in a continuous and real-time manner such that a plurality of pieces of online intent information are collected for a plurality of search queries through search engines. As described above, blocks 702, 704, 706, 708 may be performed by the online query intent collecting module 404 of the search serving engine 402.

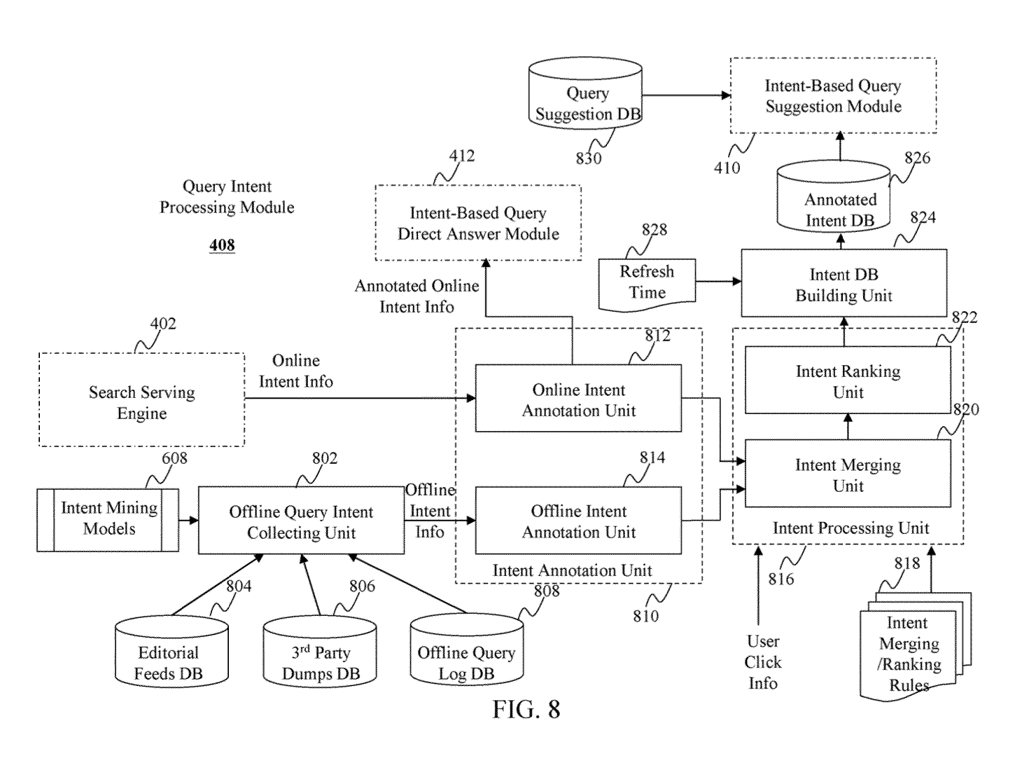

FIG. 8 is an exemplary diagram of a query intent processing module of an intent-based search assistance engine of the system for intent-based search assistance shown in FIG. 4, according to an embodiment of the present teaching. The query intent processing module 408, in addition to receiving online intent information from the search serving engine 402 at real-time, may collect offline intent information through an offline query intent collecting unit 802 from one or more offline sources, such as an editorial feeds database 804, third party dumps database 806, and offline query log database 808. The online and offline intent information are complementary to each other in the sense that the offline collection is batched and might be delayed but provides a broader coverage than the online collection. The editorial feeds database 804 may include user intents explicitly programmed by an editorial. For example, a feed list of all popular celebrity names or band names may be used for capturing user intents to find information about the corresponding celebrity or band. Such feeds or lists may be regularly updated by an editorial, in order to reflect the hottest events or newly formed bands. As to the third party dumps database 806, any third party partners of the system 400 for intent-based search assistance may provide content, and the system 400 may display their content as appropriate for the users when the content suits their intents. For example, the third party partner may provide a list of items, which may be converted to searchable queries, for each of their content explicitly. The offline query log database 808 may include a very large number of historical query logs from users. From the query logs, the offline query intent collecting unit 802 may get hold of the information of the query terms and which user intents were detected for this query by any known intent mining models 608, such as data aggregation and data joining algorithms. Compared with the online query log database 606 used for online intent detection, the offline query log database 808 may include a much larger number of query logs for a more comprehensive data mining analysis due to the less strict latency requirement for offline intent detection. The query intent processing module 408 may further assign an offline ranking score to each intent, which indicates the degree of relevance between each offline intent and the associated query. The offline ranking score is part of the intent priority in the annotation information for each intent, as shown in FIG. 14.

The query intent processing module 408 in this example also includes an intent annotation unit 810 configured to associate the plurality of pieces of intent information with a plurality of pieces of annotation information to generate a plurality of pieces of annotated intent information based on the received online and offline intent information. In this example, considering the different latency requirements for online and offline intent information, the intent annotation unit 810 may include an online intent annotation unit 812 for processing online intent information and an offline intent annotation unit 814 for processing offline intent information. As discussed above with respect to FIG. 14, the annotation information includes one or more attributes such as intent category, intent priority including offline and online ranking scores, query frequency, query location, user click feedback, dispatch parameter, and any other suitable information. The intent-based query direct answer module 412 has a strict latency requirement as it needs to provide an instant answer in response to a search query. In this example, the online intent information may be received from the search serving engine 402 at real-time and persisted as a stream of intent events to be fed into the intent-based query direct answer module 412 whenever is necessary. In other words, the query intent processing module 408 may serve as a cache storing real-time user intent feedback such that the intent-based query direct answer module 412 may fetch the annotated online intent information from the cache with minimum latency.

The query intent processing module 408 in this example further includes an intent processing unit 816 for merging and ranking multiple intents collected from different sources for the same query. The intent processing unit 816 includes an intent merging unit 820 configured to, for each query, merge the corresponding annotated online intent information and offline intent information to generate annotated intent information based on predefined intent merging/ranking rules 818. In one example, a predefined intent merging rule includes: (1) if the same query has intents collected from more than one sources, then the intents from all sources are combined into a single list; (2) if in the combined list, there are duplicates, the duplicates are removed to keep a single copy; (3) if in the combined list, there are conflicts, then the conflicts are resolved by honoring the following precedence of the sources: (a) online collected intents, (b) editorial feeds, (c) third-party dumps, and (d) intents mined from offline query logs. Conflicts mean that the intents are the same, but the annotated information associated with the intents are different, for example, the dispatch parameters or the intent priorities are different. After merging, an intent ranking unit 822 may be applied to sort the list of intents for each query by their intent priorities. As mentioned above, the intent priorities may include both online and offline ranking scores for intents collected both online and offline. In this situation, the online ranking score may have a higher weight than the offline ranking score. Additional intent merging/ranking rules 818 may be applied to adjust the ranking. For example, user click information such as click feedback may be taken into consideration for intent ranking. Or, even more sophisticated but well-known machine learning based models may be adopted.

The query intent processing module 408 in this example further includes an intent database building unit 824 configured to periodically store all the annotated intent information from the intent processing unit 816 in an annotated intent database 826. The refresh time 828 for updating the annotated intent database 826 may be predefined to be, for example, one day or one hour. In other words, the processed annotated intent information associated with search queries is periodically published to the intent-based query suggestion module 410. The intent-based query suggestion module 410 may provide a list of query suggestions fetched from a query suggestion database 830 and present, on top of the list, one or more query suggestions with explicit intents fetched from the annotated intent database 826.

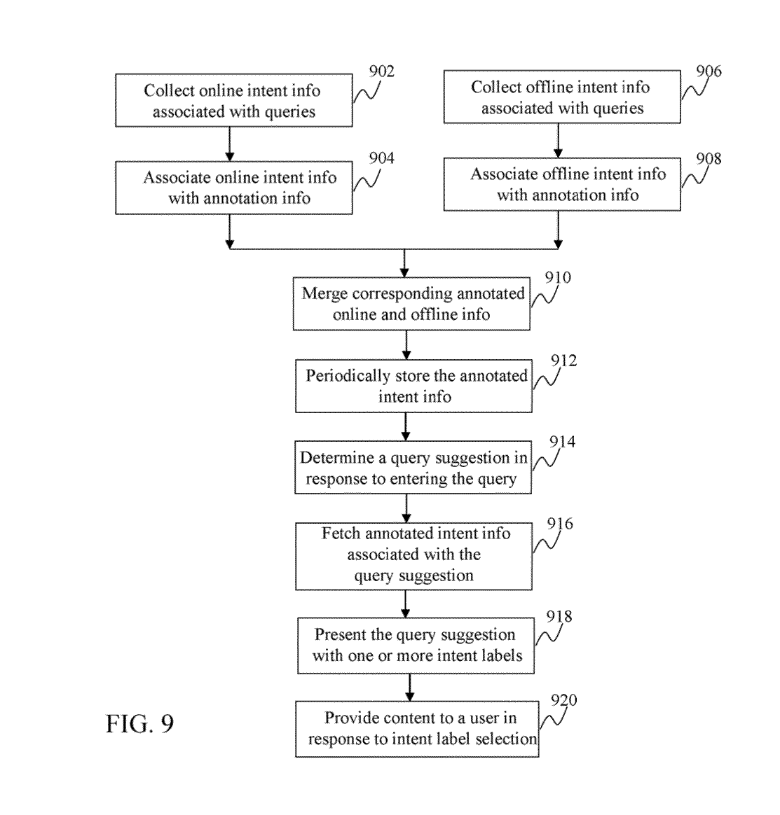

FIG. 9 is a flowchart of still another exemplary process for intent-based search assistance, according to an embodiment of the present teaching. It will be described with reference to the above figures. However, any suitable module or unit may be employed. At block 902, online intent information associated with search queries is continuously collected at real-time. As described above, this may be performed by the online query intent collecting module 404 of the search serving engine 402. At block 904, the collected online intent information is associated with annotation information to form annotated online intent information for search queries. As described above, this may be performed by the online intent annotation unit 812 of the query intent processing module 408. At block 906, offline intent information associated with search queries is collected. As described above, this may be performed by the offline query intent collecting unit 802 of the query intent processing module 408. At block 908, the collected offline intent information is associated with annotation information to form annotated offline intent information for search queries. As described above, this may be performed by offline intent annotation unit 814 of the query intent processing module 408. At block 910, processing may continue where for each query, the corresponding annotated online intent information and offline intent information are merged to generate annotated intent information. As described above, this may be performed by the intent merging unit 820 of the query intent processing module 408. Moving to block 912, the annotated intent information is periodically stored in a database. As described above, this may be performed by the intent database building unit 824 of the query intent processing module 408.

Proceeding to block 914, a query suggestion may be determined from a plurality of query suggestions in response to a user entering a search query. As discussed above, the plurality of query suggestions are fetched using any known approaches, e.g., prefix matching, from the query suggestion database 830, which is built offline based on past searching behaviors of a large number of users, and any knowledge database (not shown). At least the most relevant query suggestion may be chosen from the fetched query suggestions based on their associated annotation information, such as intent priority, query frequency, user click feedback, etc., as discussed above. Moving to block 916, annotated intent information associated with the determined query suggestion is fetched. At block 918, the determined query suggestion is presented to the user with one or more intent labels for the user to select. As discussed above, more than one intent may be associated with each query suggestion, and each intent may be assigned to an intent category with a display label. Thus, if the determined most relevant query suggestion has more than one associated search intent, the possible search intents are explicitly displayed by their intent labels in a ranked manner for disambiguation.

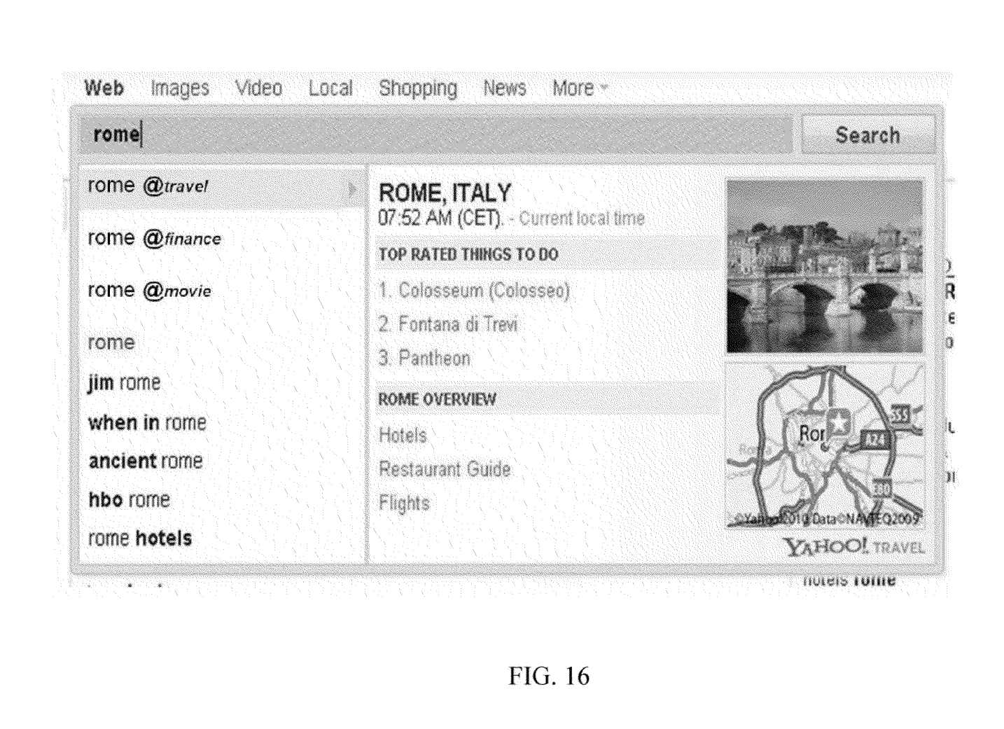

Referring now to FIG. 16, “rome” is determined as the most relevant query suggestion for the search query “rome” and thus, is displayed on top of the list of all query suggestions. As the query suggestion “rome” may have multiple associated intents fetched from the annotated intent database 826, the three intents ranked the highest, i.e., “travel,” “finance,” and “movie,” are explicitly presented as labels with the query suggestion for the user to make further selection. As described above, this may be performed by the intent-based query suggestion module 410. At block 920, content is provided in response to the user selecting one label. The content is obtained based on the intent indicated by the selected label. For example, in FIG. 16, once the user selects, e.g., highlights, the query suggestion with the label “travel,” content related to traveling in Rome, such as local time, places of interest, hotels, restaurants, flight information, and maps, is provided to the user in the right panel as a direct answer to the search query “rome.” Although the processing in FIG. 9 is illustrated in a particular order, those having ordinary skill in the art will appreciate that the processing can be performed in different orders.

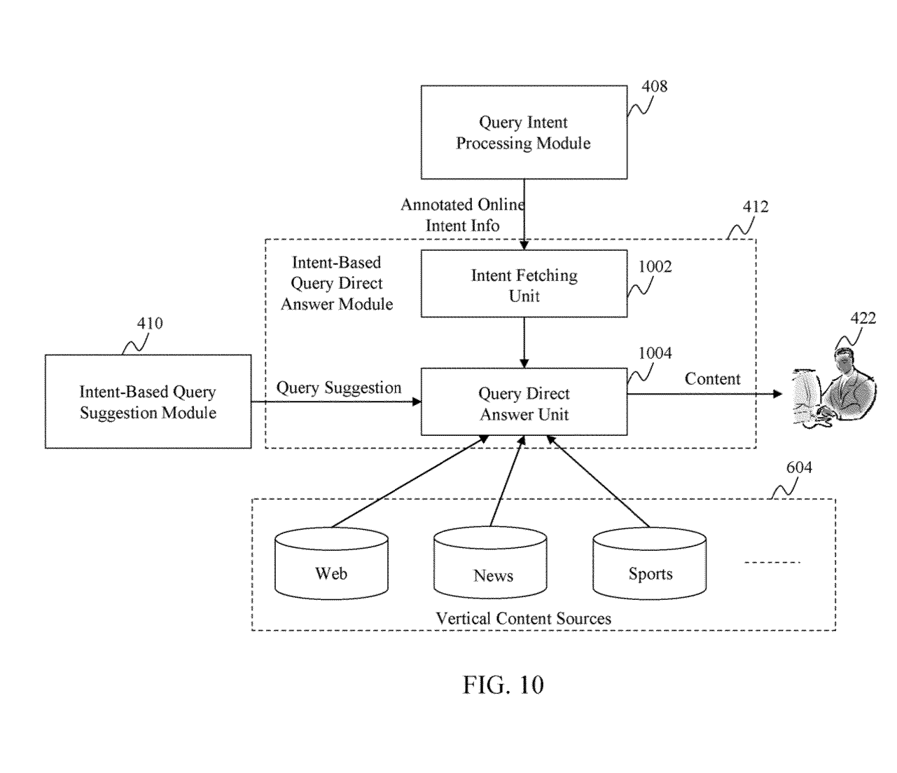

FIG. 10 is an exemplary diagram of an intent-based query direct answer module of an intent-based search assistance engine of the system for intent-based search assistance shown in FIG. 4, according to an embodiment of the present teaching. The intent-based query direct answer module 412 in this example includes an intent fetching unit 1002 and a query direct answer unit 1004. The query direct answer unit 1004 is configured to receive the most relevant query suggestion from the intent-based query suggestion module 410. As discussed above, the query suggestion may be chosen from a plurality of query suggestions fetched by the intent-based query suggestion module 410 based on their associated annotation data. It is understood that in other examples, the query suggestion may be determined in a different way. For example, the query suggestion may be manually selected by the user 422 or the default query suggestion on top of the list of fetched query suggestions, which is determined by users' general searching behaviors without considering a specific user's 422 search intent. In any event, the intent fetching unit 1002 is configured to fetch the annotated online intent information associated with the query suggestion received by the query direct answer unit 1004. The online intent annotation information might provide more relevant intent at real-time for query direct answer unit 1004 in order to provide the most update/relevant to date content as the direct answer. In this example, vertical content sources 604 and/or any third party services (not shown) may be called by the query direct answer unit 1004 in order to fetch the most relevant and fresh answer based on the query suggestion and its associated annotation information. For example, a news server may be called in order to provide the latest news article if the intent for a query suggestion is “news.” As mentioned before, the content fetching may be performed based on the dispatch parameter in the annotation information for each intent. In one example, the intent-based query direct answer module 412 may present news about FACEBOOK IPO, instead of the homepage of FACEBOOK, as direct answers to the query “facebook” based on real-time feedback from search serving engine 402 for FACEBOOK IPO buzz.

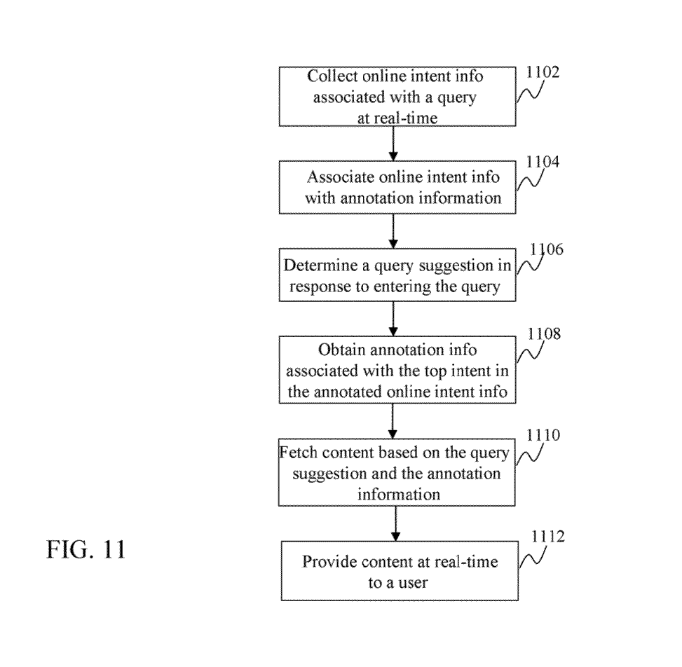

FIG. 11 is a flowchart of yet another exemplary process for intent-based search assistance, according to an embodiment of the present teaching. It will be described with reference to the above figures. However, any suitable module or unit may be employed. Starting at block 1102, online intent information associated with a search query is collected at real-time. As described above, this may be performed by the online query intent collecting module 404 of the search serving engine 402. At block 1104, the collected online intent information is associated with annotation information to generate annotated online intent information. As described above, this may be performed by the online intent annotation unit 812 of the query intent processing module 408. At block 1106, processing may continue where a query suggestion is determined from a plurality of query suggestions in response to entering the query. As described above, this may be performed by the intent-based query suggestion module 410. Moving to block 1108, annotation information associated with the top intent for the determined query suggestion is obtained. As there may be more than one intent associated with the determined query suggestions, the intent ranked the highest needs to be identified. As described above, this may be performed by the intent fetching unit 1002 of the intent-based query direct answer module 412. At block 1110, content is fetched based on the determined query suggestion and the annotation information associated with the top intent from content sources, for example, by the dispatch parameter of the top intent. As described above, this may be performed by the query direct answer unit 1004 of the intent-based query direct answer module 412. Eventually, at block 1112, the fetched content is provided to the user at real-time, for example, in the right panel of a web browser or a standalone search application. The content may be in any suitable form, such as but not limited to, text, hyperlink, image, video, or audio.

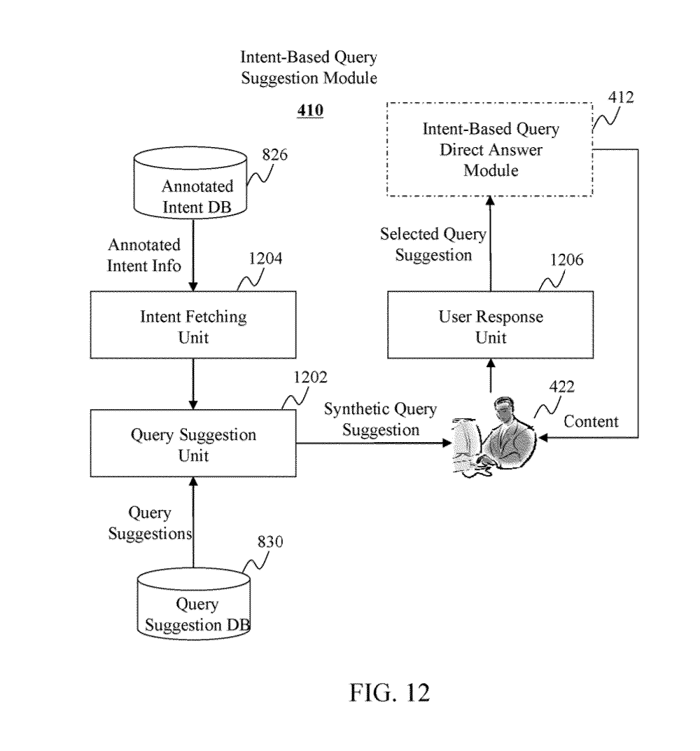

FIG. 12 is an exemplary diagram of an intent-based query suggestion module of an intent-based search assistance engine of the system for intent-based search assistance shown in FIG. 4, according to an embodiment of the present teaching. The intent-based query suggestion module 410 in this example includes a query suggestion unit 1202, an intent fetching unit 1204, and a user response unit 1206. The query suggestion unit 1202 is configured to fetch a list of query suggestions from the offline-built search suggestion database 830 in response to entering a search query by the user 422. As the user 422 types a new character in the search box, the list of query suggestions may be refreshed instantly for example, in less than 10 ms. The query suggestion database 830 may include only query strings with some feature data for ranking the query strings. The intent fetching unit 1204 is then responsible for fetching the annotated intent information for one or more query suggestions ranked on top of the list. It is noted that the annotated intent database 826 in this example is built as a separate database from the query suggestion database 830 because rebuilding the query suggestion database 830 with updated annotation information would take extra resources. However, it is understood that in some examples, the two databases may be merged to rebuild a new database.

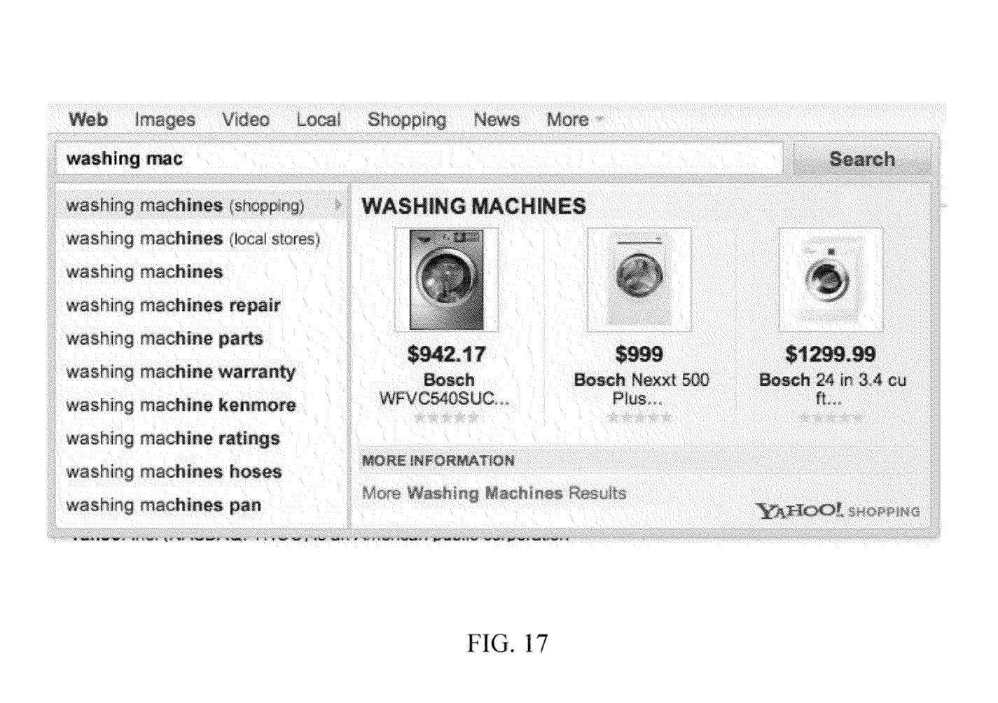

The fetched annotated intent information may be applied to explicitly present intents with one or more query suggestions, as synthetic query suggestions, to the user 422. The intent fetching unit 1204 may fetch the annotation information for each of the top n most relevant query suggestions. In one example, n equals to 10. The intent(s) associated with one of the top n most relevant query suggestions, e.g., the one highlighted by the user or the one on top of the list by default, are presented to the user. If the fetched annotation intent information for the determined query suggestion includes multiple intents, the query suggestion unit 1202 may expand the determined query suggestion into multiple entries. The top 1 to N entries correspond to the N intents, which are suitable for explicit callout, and the (N+1)th entry corresponds to the query suggestion without explicit intent callout. Referring now to FIG. 16, in this example, the determined query suggestion “rome” has multiple intents. It is associated with three intents suitable for explicit callout, which are “travel,” “finance,” and “movie,” sorted by intent priorities in this order, and one intent unsuitable for explicit callout, for example, “ads.” The top query suggestion “rome” is then expanded into four entries: rome@travel, rome@finance, rome@movie, and rome. A blacklist of intents unsuitable for explicit callout, such as “ads,” and/or a whitelist of intents suitable for explicit callout may be maintained by the query suggestion unit 1202, so that only whitelisted (or not blacklisted) intents can be expanded and displayed with explicit labels. The rest of the intents then may go to the last implicit synthetic suggestion with an implicit label (e.g., no label). In another example shown in FIG. 17, “washing machines” is determined as the most relevant query suggestion for search query “washing mac.” The “washing machines” is associated with two explicit intents, i.e., “shopping” and “local stores” and other intents unsuitable for explicit callout. The “washing machines” query suggestion is then expanded into three entries: “washing machines (shopping),” “washing machines (local stores)” and “washing machines.”

The user response unit 1206 in this example is configured to receive the user's selection of one of the query suggestion entries with different intent labels, including explicit and implicit labels. The selected query suggestion may be sent to the intent-based query direct answer module 412 for providing a direct answer to the search query, as discussed above. For example, in FIG. 16, content related to the city of Rome for traveling is displayed as a direct answer once the user 422 selects “rome@travel.” In FIG. 17, content related to washing machines shopping, such as model, price, and review, is displayed in response to the selection of “washing machines (shopping).”

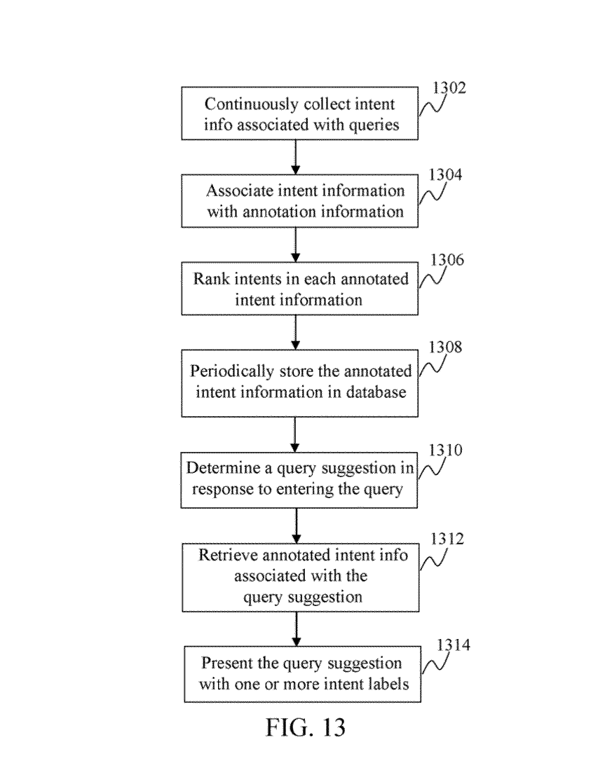

FIG. 13 is a flowchart of yet another exemplary process for intent-based search assistance, according to an embodiment of the present teaching. It will be described with reference to the above figures. However, any suitable module or unit may be employed. Starting at block 1302, both online and offline intent information associated with search queries is continuously collected. As described above, this may be performed by the online query intent collecting module 404 of the search serving engine 402 in conjunction with the offline query intent collecting unit 802 of the query intent processing module 408. At block 1304, the collected online and offline intent information is associated with annotation information to generate annotated online and offline intent information. As described above, this may be performed by the intent annotation unit 810 of the query intent processing module 408. Proceeding to block 1306, for each query associated with more than one intent, the intents are ranked. As described above, this may be performed by the intent ranking unit 822 of the query intent processing module 408. At block 1308, processing may continue where the annotated intent information is periodically stored in a database. As described above, this may be performed by the intent database building unit 824 of the query intent processing module 408. Moving to block 1310, a query suggestion is determined from a plurality of query suggestions, for example, based on their associated annotation information. As described above, this may be performed by the intent-based query suggestion module 410. At block 1312, annotated intent information associated with the determined query suggestion is retrieved. The annotated intent information including one or more intents with annotation information. As described above, this may be performed by the intent fetching unit 1204 of the intent-based query suggestion module 410. Eventually, at block 1314, the determined query suggestion is presented with one or more labels to the user. The one or more labels are ranked based on their corresponding intents. As described above, this may be performed by the query suggestion unit 1202 of the intent-based query suggestion module 410.

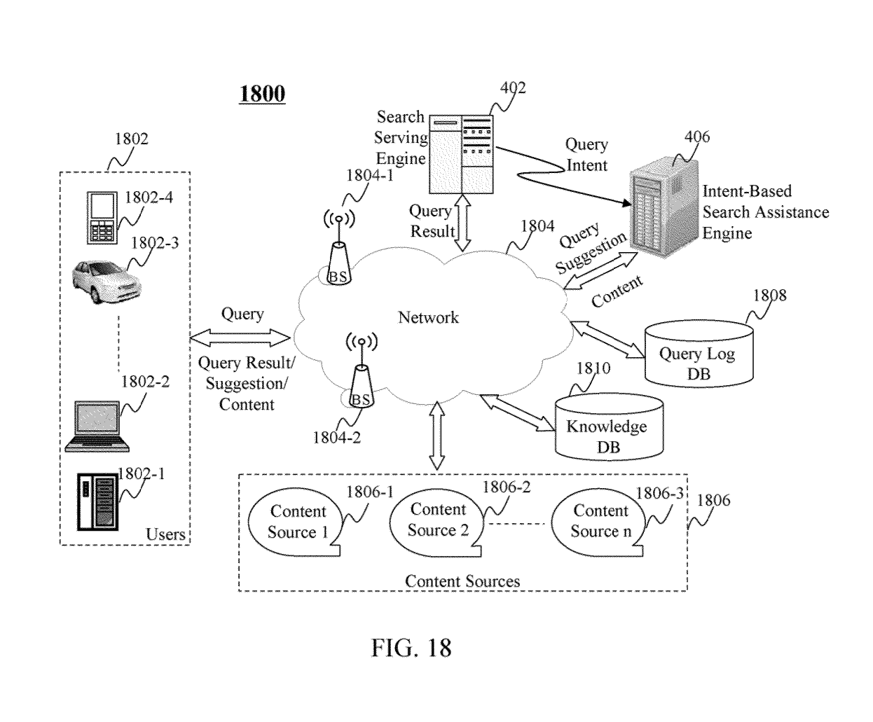

FIG. 18 depicts an exemplary embodiment of a networked environment in which intent-based search assistance is applied, according to an embodiment of the present teaching. In FIG. 18, the exemplary networked environment 1800 includes the search serving engine 402, the intent-based search assistance engine 406, one or more users 1802, a network 1804, content sources 1806, a query log database 1808, and a knowledge database 1810. The network 1804 may be a single network or a combination of different networks. For example, the network 1804 may be a local area network (LAN), a wide area network (WAN), a public network, a private network, a proprietary network, a Public Telephone Switched Network (PSTN), the Internet, a wireless network, a virtual network, or any combination thereof. The network 1804 may also include various network access points, e.g., wired or wireless access points such as base stations or Internet exchange points 1804-1, . . . , 1804-2, through which a data source may connect to the network in order to transmit information via the network.

Users 1802 may be of different types such as users connected to the network 1804 via desktop computers 1802-1, laptop computers 1802-2, a built-in device in a motor vehicle 1802-3, or a mobile device 1802-4. A user may send a query to the search serving engine 402 and the intent-based search assistance engine 406 via the network 1804 and receive a query result from the search serving engine 402 and query suggestions and content of direct answers from the intent-based search assistance engine 406. The search serving engine 402 provides real-time online query intent feedback detected based on the query to the intent-based search assistance engine 406. In addition, the intent-based search assistance engine 406 may also access additional information, via the network 1804, stored in the query log database 1808 and knowledge database 1810 for collecting offline intent information. The information in the query log database 1808 and knowledge database 1810 may be generated by one or more different applications (not shown), which may be running on the search serving engine 402, at the backend of the search serving engine 402, or as a completely standalone system capable of connecting to the network 1804, accessing information from different sources, analyzing the information, generating structured information, and storing such generated information in the query log database 1808 and knowledge database 1810.

The content sources 1806 include multiple content sources 1806-1, 1806-2, . . . , 1806-3, such as vertical content sources. A content source may correspond to a website hosted by an entity, whether an individual, a business, or an organization such as USPTO.gov, a content provider such as cnn.com and Yahoo.com, a social network website such as Facebook.com, or a content feed source such as tweeter or blogs. The search serving engine 402 and the intent-based search assistance engine 406 may access information from any of the content sources 1806-1, 1806-2, . . . , 1806-3. For example, the search serving engine 402 may fetch content, e.g., websites, through its web crawler to build a search index. The intent-based query direct answer module 412 of the intent-based search assistance engine 406 may fetch content from the content sources 1806 as the direct answer to the search query based on a dispatch parameter in the annotation information.

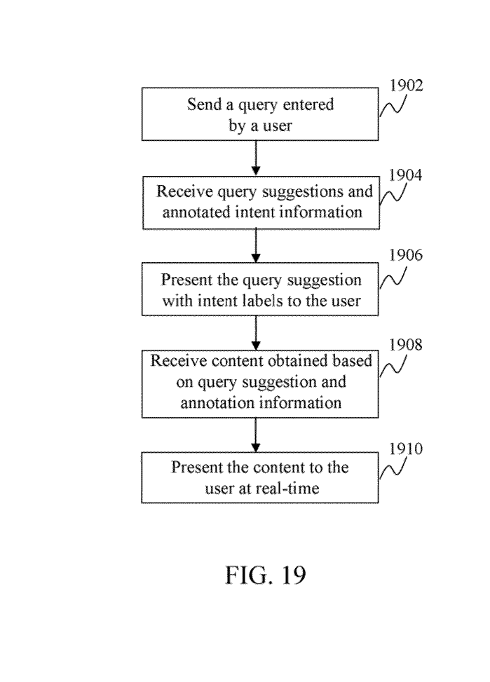

FIG. 19 is a flowchart of yet another exemplary process for intent-based search assistance, according to an embodiment of the present teaching. It will be described with reference to the above figures. However, any suitable module or unit may be employed. This exemplary process is described from users/user devices' perspective. Beginning at block 1902, a query entered by a user is sent. The query may be a partial query, e.g., characters or strings. As described above, this may be performed by the transmitter 420 of the user device 414. At block 1904, query suggestions and annotated intent information associated with at least one of the query suggestions are received. The annotated intent information includes one or more intents determined based on the at least one query suggestion. As described above, this may be performed by the receiver 418 of the user device 414. Moving to block 1906, the query suggestions are presented to the user. At least one query suggestion is presented with one or more labels each indicating a search intent. As described above, this may be performed by the display 416 of the user device 414. At block 1908, processing may continue where content of a direct answer to the query is received. The content is obtained based on the at least one query suggestion and annotation information associated with an intent for the query. As described above, this may be performed by the receiver 418 of the user device 414. At block 1910, the obtained content is presented to the user at real-time as the direct answer to the query. As described above, this may be performed by the display 416 of the user device 414.

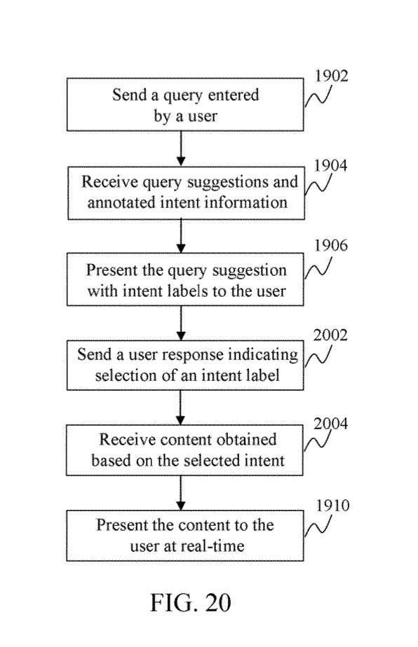

FIG. 20 is a flowchart of yet another exemplary process for intent-based search assistance, according to an embodiment of the present teaching. It will be described with reference to the above figures. However, any suitable module or unit may be employed. This exemplary process is described from users/user devices' perspective. Beginning at block 1902, a query entered by a user is sent. The query may be a partial query, e.g., characters, strings. As described above, this may be performed by the transmitter 420 of the user device 414. At block 1904, query suggestions and annotated intent information associated with at least one of the query suggestions are received. The annotated intent information includes one or more intents determined based on the at least one query suggestion. As described above, this may be performed by the receiver 418 of the user device 414. Moving to block 1906, the query suggestions are presented to the user. At least one query suggestion is presented with one or more labels each indicating a search intent. As described above, this may be performed by the display 416 of the user device 414. At block 2002, processing may continue where a user response indicating selection of an intent label is sent. As described above, this may be performed by the transmitter 420 of the user device 414. At block 2004, content obtained based on the intent indicated by the selected label is received. As described above, this may be performed by the receiver 418 of the user device 414. At block 1910, the obtained content is presented to the user at real-time as the direct answer to the query. As described above, this may be performed by the display 416 of the user device 414.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

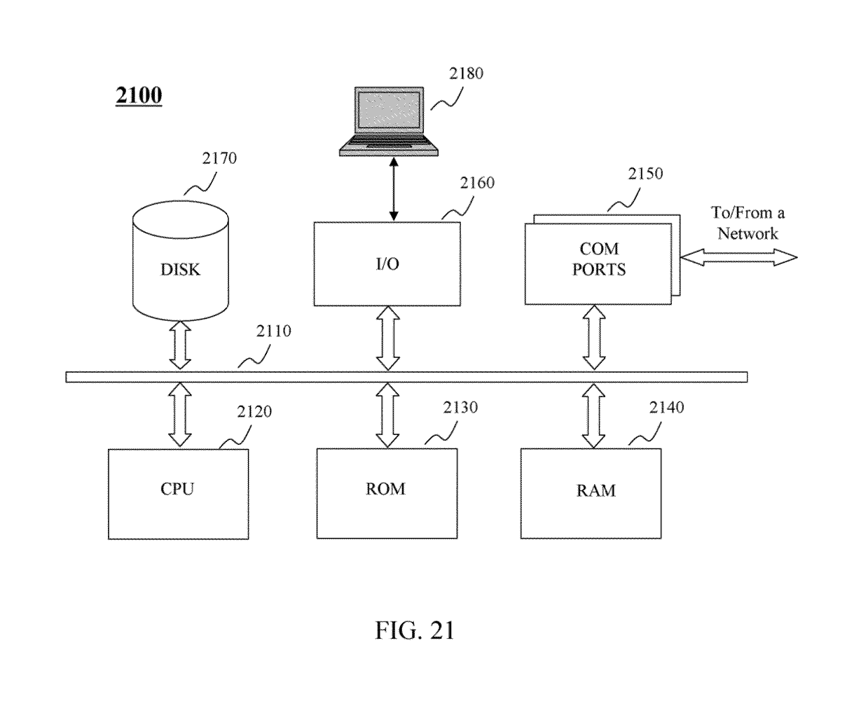

FIG. 21 depicts a general computer architecture on which the present teaching can be implemented and has a functional block diagram illustration of a computer hardware platform that includes user interface elements. The computer may be a general-purpose computer or a special purpose computer. This computer 2100 can be used to implement any components of the search assistance architecture as described herein. Different components of the system, e.g., as depicted in FIG. 4, can all be implemented on one or more computers such as computer 2100, via its hardware, software program, firmware, or a combination thereof. Although only one such computer is shown, for convenience, the computer functions relating to search assistance may be implemented in a distributed fashion on a number of similar platforms, to distribute the processing load.

The computer 2100, for example, includes COM ports 2102 connected to and from a network connected thereto to facilitate data communications. The computer 2100 also includes a central processing unit (CPU) 2104, in the form of one or more processors, for executing program instructions. The exemplary computer platform includes an internal communication bus 2106, program storage and data storage of different forms, e.g., disk 2108, read only memory (ROM) 2110, or random access memory (RAM) 2112, for various data files to be processed and/or communicated by the computer, as well as possibly program instructions to be executed by the CPU. The computer 2100 also includes an I/O component 2114, supporting input/output flows between the computer and other components therein such as user interface elements 2116. The computer 2100 may also receive programming and data via network communications.

Hence, aspects of the method of search assistance, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method, implemented on at least one machine each of which has at least one processor, storage, and a communication platform connected to a network for intent-based search assistance, the method comprising the steps of:
collecting intent information associated with a query entered by a user, the intent information including one or more intents;
associating the collected intent information with annotation information to generate annotated intent information for the query;
in response to the user entering the query, determining a query suggestion from a plurality of query suggestions;
presenting the determined query suggestion to the user with one or more labels each indicating one of the one or more intents, wherein the labels include one or more explicit labels indicating intents suitable for explicit callout and an implicit label indicating intents unsuitable for explicit callout; and
providing content to the user at real-time based on the determined query suggestion and the annotated intent information for the query.

2. The method of claim 1, wherein the step of collecting intent information comprise:
receiving the query from the user;
determining the one or more intents associated with the query using data mining approaches based on query logs at real-time; and
ranking the one or more intents based on data mining results and user click feedback.

3. The method of claim 2, wherein the step of providing content comprises:
obtaining annotation information associated with one of the intents that is on top of the ranking; and
fetching the content based on the determined query suggestion and the retrieved annotation information.

4. The method of claim 1, further comprising the steps of:
continuously collecting a plurality of pieces of intent information associated with a plurality of queries;
associating the plurality of pieces of intent information with a plurality of pieces of annotation information to generate a plurality of pieces of annotated intent information;
for each annotated intent information that includes a plurality of intents, ranking the plurality of intents; and
periodically storing the plurality of pieces of annotated intent information in a database.

5. (canceled)

6. The method of claim 1, wherein the query suggestion is determined from the plurality of query suggestions based on their associated annotation information.

7. The method of claim 1, wherein the annotation information includes at least one of intent category, intent priority, query frequency, query location, user click feedback, and dispatch parameter.

8. A system for intent-based search assistance, comprising:
an online query intent collecting module implemented on a processor of a computer and configured to collect intent information associated with a query entered by a user, the intent information including one or more intents;
a query intent processing module configured to associate the collected intent information with annotation information to generate annotated intent information for the query;
an intent-based query suggestion module configured to:
in response to the user entering the query, determine a query suggestion from a plurality of query suggestions,
present the determined query suggestion to the user with one or more labels each indicating one of the one or more intents, wherein the labels include one or more explicit labels indicating intents suitable for explicit callout and an implicit label indicating intents suitable for explicit callout; and
an intent-based query direct answer module configured to provide content to the user at real-time based on the determined query suggestion and the annotated intent information for the query.

9. The system of claim 8, wherein the online query intent detecting module is further configured to:
receive the query from the user;
determine the one or more intents associated with the query using data mining approaches based on query logs at real-time; and
ranking the one or more intents based on data mining results and user click feedback.

10. The system of claim 9, wherein the intent-based query direct answer module is further configured to;
obtain annotation information associated with one of the one or more intents that is on top of the ranking; and
fetch the content based on the determined query suggestion and the obtained annotation information.

11. The system of claim 8, wherein the online query intent detecting module is further configured to continuously collect a plurality of pieces of intent information associated with a plurality of queries, and
the query intent processing module is further configured to:
associate the plurality of pieces of intent information with a plurality of pieces of annotation information to generate a plurality of pieces of annotated intent information;
for each annotated intent information that includes a plurality of intents, rank the plurality of intents; and
periodically store the plurality of pieces of annotated intent information in a database.

12. (canceled)

13. The system of claim 8, wherein the query suggestion is determined from the plurality of query suggestions based on their associated annotation information.

14. The system of claim 8, wherein the annotation information includes at least one of intent category, intent priority, query frequency, query location, user click feedback, and dispatch parameter.

15. A machine-readable tangible and non-transitory medium having information for intent-based search assistance recorded thereon, wherein the information, when read by the machine, causes the machine to perform the following:
collecting intent information associated with a query entered by a user, the intent information including one or more intents;
associating the collected intent information with annotation information to generate annotated intent information for the query;
in response to the user entering the query, determining a query suggestion from a plurality of query suggestions;
presenting the determined query suggestion to the user with one or more labels each indicating one of the one or more intents, wherein the labels include one or more explicit labels indicating intents suitable for explicit call out and an implicit label indicating intents unsuitable for explicit callout; and
providing content to the user at real-time based on the determined query suggestion and the annotated intent information for the query.

16. The medium of claim 15, wherein the step of collecting intent information comprise:
receiving the query from the user;
determining the one or more intents associated with the query using data mining approaches based on query logs at real-time; and
ranking the one or more intents based on data mining results and user click feedback.

17. The medium of claim 16, wherein the step of providing content comprises:
retrieving annotation information associated with one of the intents that is on top of the ranking; and
fetching the content based on the determined query suggestion and the retrieved annotation information.

18. The medium of claim 15, further comprising the steps of:
continuously collecting a plurality pieces of intent information associated with a plurality of queries;
associating the plurality of pieces of intent information with a plurality of pieces of annotation information to generate a plurality of annotated intent information;
for each annotated intent, information that includes a plurality of intents, ranking the plurality of intents; and
periodically storing the plurality of pieces of annotated intent information in a database.

19. (canceled)

20. The medium of claim 15, wherein the query suggestion is determined from the plurality of query suggestions based on their associated annotation information.

21. The medium of claim 15, wherein the annotation information includes at least one of intent category, intent priority, query frequency, query location, user click feedback, and dispatch parameter.

22. A method, implemented on at least one machine each of which has at least one processor, storage, and a communication platform connected to a network for intent-based search assistance, the method comprising the steps of:
sending a query entered by a user;
receiving a plurality of query suggestions and annotated intent information associated with at least one of the plurality of query suggestions, wherein the annotated intent information includes one or more intents determined based on the at least one query suggestion;
presenting the plurality of query suggestions to the user, wherein the at least one query suggestion is presented with one or more labels each indicating one of the one or more intents, and the labels include one or more explicit labels indicating intents suitable for explicit callout and an implicit label indicating intents unsuitable for explicit callout;
receiving content obtained based on the at least one query suggestion and annotation information associated with an intent, the intent being determined based on the query entered by the user; and
presenting the content to the user at real-time.

23. An apparatus for intent-based search assistance, comprising:
a transmitter configured to send a query entered by a user;
a receiver configured to:
receive a plurality of query suggestions and annotated intent information associated with at least one of the plurality of query suggestions, wherein the annotated intent information includes one or more intents determined based on the at least one query suggestion, and
receive content obtained based on the at least one query suggestion and annotation information associated with an intent, the intent being determined based on the query entered by the user; and
a display configured to:
present the plurality of query suggestions to the user, wherein the at least one query suggestion is presented with one or more labels each indicating one of the one or more intents, and the labels include one or more explicit labels indicating intents suitable for explicit callout and an implicit label indicating intents unsuitable for explicit callout and
present the content to the user at real-time.

24. A machine-readable tangible and non-transitory medium having information for intent-based search assistance recorded thereon, wherein the information, when read by the machine, causes the machine, to perform the following:
sending a query entered by a user,
receiving a plurality of query suggestions and annotated intent information associated with at least one of the plurality of query suggestions, wherein the annotated intent information includes one or more intents determined based on the at least one query suggestion;
presenting the plurality of query suggestions to the user, wherein the at least one query suggestion is presented with one or more labels each indicating one of the one or more intents, and the labels include one or more explicit labels indicating intents suitable for explicit callout and an implicit label indicating intents unsuitable for explicit callout;
receiving content obtained based on the at least one query suggestion and annotation information associated with an intent, the intent being determined based on the query entered by the user; and
presenting the content to the user at real-time.
